(19) United States
(12) Patent Application Publication
(10) Pub. No.: US 2014/0119081 A1
(43) Pub. Date: May 1, 2014

(54) POWER CONVERSION APPARATUS

(71) Applicants: Nippon Soken, Inc., Nishio-city (JP); Denso Corporation, Kariya-city (JP)

(72) Inventors: Hiroyasu BABA, Kariya-shi (JP); Koji KAWASAKI, Anjo-shi (JP); Yasuyuki HASEO, Nishio-shi (JP); Hironori ASA, Okazaki-shi (JP)

(73) Assignees: NIPPON SOKEN, INC., Nishio-city (JP); DENSO CORPORATION, Kariya-city (JP)

(21) Appl. No.: 14/063,416

(22) Filed: Oct. 25, 2013

(30) Foreign Application Priority Data
Oct. 25, 2012 (JP) 2012-235872

(51) Int. Cl. H02M 7/539

(52) U.S. Cl. CPC H02M 7/539
USPC 363/95

(57) ABSTRACT

A power conversion apparatus is applied to an assembled battery which is a series connection of a plurality of unit batteries, two or more and at least part of the plurality of unit batteries being selection objects. The apparatus includes a voltage output section which outputs voltage, opening and closing sections each of which is provided on each current path connecting each of the selection objects with the voltage output section and which is opened and closed to open and close the current path, and an operation section which operates the opening and closing sections so that the voltage output section outputs AC voltage.

### CROSS-REFERENCE TO RELATED APPLICATION

This application is based on and claims the benefit of priority from earlier Japanese Patent Application No. 2012-235872 filed Oct. 25, 2012, the description of which is incorporated herein by reference.

### BACKGROUND

1. Technical Field

The present invention relates to a power conversion apparatus applied to an assembled battery, which is a series connection of a plurality of unit batteries.

2. Related Art

Conventionally, as described in 3P-A-2006-320074, a technique is known which is for converting DC voltage of a battery into AC voltage to be outputted to external loads. In particular, a positive electrode terminal of the battery is connected to one end of an output terminal (connector) via a first current path. In addition, the positive electrode and a negative electrode of the battery are connected to a motor generator via a three-phase inverter. A neutral point of a three-phase coil configuring the motor generator is connected to the other end of the connector via a second current path.

In the above configuration, switching elements configuring the Inverter are opened and closed by using an operation signal generated by a PWM process to generate AC voltage having a frequency of a commercial power supply at the neutral point.

However, according to the technique described in JP-A-2006-320074, since the switching elements are opened and closed based on the PWM process so that AC voltage is outputted, the switching frequency tends to become higher. If the switching frequency becomes higher, switching loss can be increased.

### SUMMARY

An embodiment provides a power conversion apparatus which can decrease switching loss caused when DC voltage is converted to AC voltage.

As an aspect of the embodiment, a power conversion apparatus is provided, which is applied to an assembled battery which is a series connection of a plurality of unit batteries, two or more and at least part of the plurality of unit batteries being selection objects. The apparatus includes a voltage output section which outputs voltage; opening and closing sections each of which is provided on each to current path connecting each of the selection objects with the voltage output section and which is opened and closed to open and close the current path; and an operation section which operates the opening and closing sections so that the voltage output section outputs AC voltage.

### BRIEF DESCRIPTION OF THE DRAWINGS

In the accompanying drawings:

FIG. 1 is a diagram showing a configuration of a system according to a first embodiment;

FIG. 2 is a diagram showing selection modes of modules according to the first embodiment;

FIG. 3 is a diagram showing an example of the selection mode of a module according to the first embodiment;

FIG. 4 is a flowchart showing a procedure of an AC voltage generation process according to the first embodiment;

FIG. 5 is a diagram showing an example of the AC voltage generation process according to the first embodiment;

FIG. 6 is a measurement result of AC voltage according to the first embodiment;

FIG. 7 is a diagram showing an effect of reduction of switching loss according to the first embodiment;

FIG. 8 is a diagram showing selection modes of modules according to a second embodiment;

FIG. 9 is a diagram showing an example of the selection mode of a module according to the second embodiment;

FIG. 10 is a measurement result of AC voltage according to the second embodiment;

FIG. 11 is a diagram showing a configuration of a system according to a third embodiment;

FIG. 12 is a diagram showing selection modes of modules according to the third embodiment;

FIG. 13 is a diagram showing a configuration of a system according to a fourth embodiment;

FIG. 14 is a diagram showing selection modes of modules according to the fourth embodiment;

FIG. 15 is a diagram showing a configuration of a system according to a fifth embodiment;

FIG. 16 is a measurement result of AC voltage according to the fifth embodiment;

FIG. 17 is a diagram showing a configuration of a system according to a sixth embodiment;

FIG. 18 is a measurement result of AC voltage according to the sixth embodiment;

FIG. 19 is a flowchart showing a procedure of an AC voltage generation process according to a seventh embodiment; and

FIG. 20 is a diagram showing an example of the AC voltage generation process according to the seventh embodiment.

### DETAILED DESCRIPTION OF THE PREFERRED EMBODIMENTS

With reference to the accompanying drawings, hereinafter are described embodiments of the present invention.

### First Embodiment

Hereinafter, the first embodiment will be described in which a power conversion apparatus is applied to a vehicle (e.g. a hybrid vehicle or an electric vehicle) including a rotating machine (motor generator) as an in-vehicle traction unit.

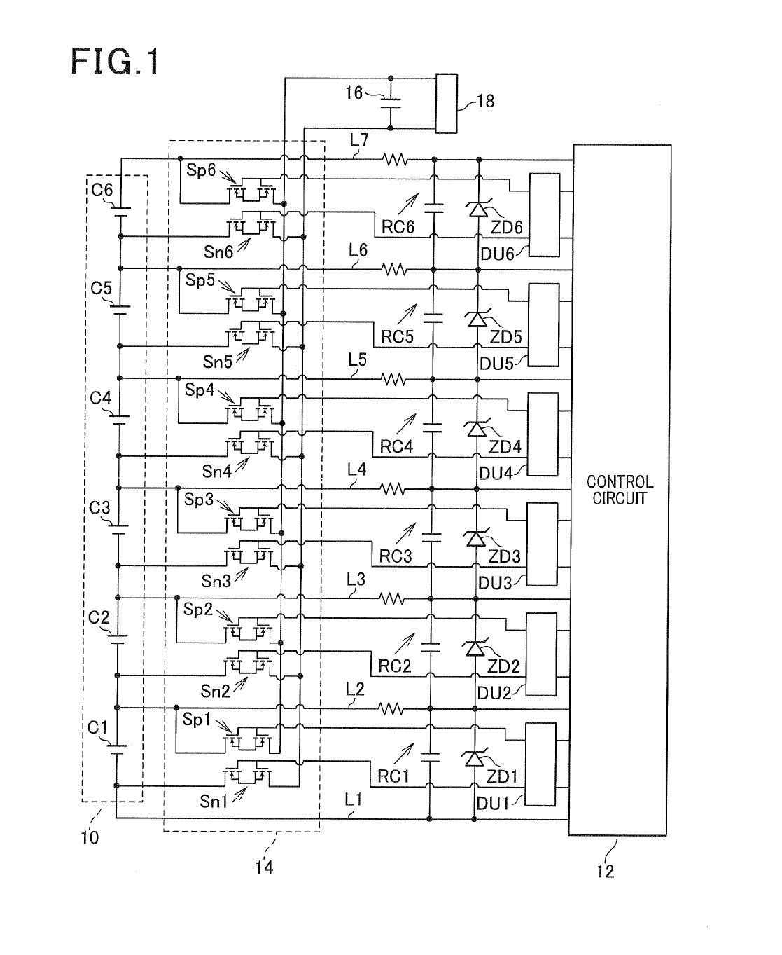

As shown in FIG. 1, an assembled battery 10 configures an in-vehicle high voltage system and serves as a power supply of the motor generator and the like. The assembled battery 10 is a series connection of modules which are unit batteries. Terminal voltage of the assembled battery 10 becomes a predetermined high voltage (e.g. several hundred volts). Note that the module is one unit battery (battery cell) or a series connection of a plurality of unit batteries adjacent to each other. Terminal voltage of one battery cell is, for example, several volts. In the present embodiment, the number of modules is six, for the sake of convenience. Hence, hereinafter, each of the modules is referred to as an ith module C(i) (i=1 to 6). Note that, in the present embodiment, a lithium-ion secondary battery is used as the assembled battery 10.

A signal line L (i+1) is connected to a positive electrode terminal of the ith module C(i). A signal line L(i) is connected to a negative electrode terminal of the ith module C(i). That is, a signal line at the negative electrode terminal side of a high electric potential side module and a signal line at the positive electrode terminal side of a low electric potential side module, where the two modules are adjacent to each other, use the same signal lines, except for signal lines L1 and L7.

The voltage of the ith module C(i) is applied to a control circuit 12 via the signal lines L(i), L(i+1) and an ith low-pass filter RC (i) including a resistor and a capacitor. The ith low-pass filter RC (i) is provided for removing high frequency noise superimposed on a voltage signal to increase detection accuracy of the voltage of the ith module C (i).

An ith Zener diode ZD (i) is connected to the ith module C (i) In parallel. The ith Zener diode ZD (i) is provided for preventing overvoltage from being applied to the ith module C (i). In particular, the cathode side of the ith Zener diode ZD (i) is connected to the signal line L (i+1), and the anode side of the ith Zener diode ZD (i) is connected to the signal line L (i).

Both ends of the ith module C (i) are connectable to both ends of a capacitor 16, which is a storage means (section), via a converter 14 including an ith p side switching element Sp (i) and an ith n side switching element Sn (i). In particular, one end of the capacitor 16 is connected to a positive electrode terminal of the ith module C (i) via the ith p side switching element Sp (i), and the other end of the capacitor 16 is connected to a negative electrode terminal of the ith module C (i) via the ith n side switching element Sn (i).

In the present embodiment, a pair of N-channel MOSFETs (metal-oxide semiconductor field-effect transistors), whose sources are short-circuited to each other, are used as the switching elements. The sources are short-circuited to each other to easily open and close the pair of N-channel MOSFETs. That is, since the N-channel MOSFET is opened and closed depending on an electric potential of the gate with respect to the source, short-circuiting the sources to each other can equalize electric potentials of the sources of the pair of N-channel MOSFETs. Furthermore, an opening and closing operation can be performed depending on a single opening and closing operation signal (voltage signal).

The both ends of the capacitor 16 are connected to a connector 18. The connector 18 is an output terminal for outputting voltage across the capacitor 16 to external loads. The connector 18 is connected to, for example, an outlet for electrical equipment (e.g. refrigerator).

The control circuit 12 includes a microcomputer, which is a main part. The control circuit 12 opens and closes the ith p side switching element Sp (i) and the ith n side switching element Sn (i) via an ith drive circuit DU (i) corresponding to the ith module C (i).

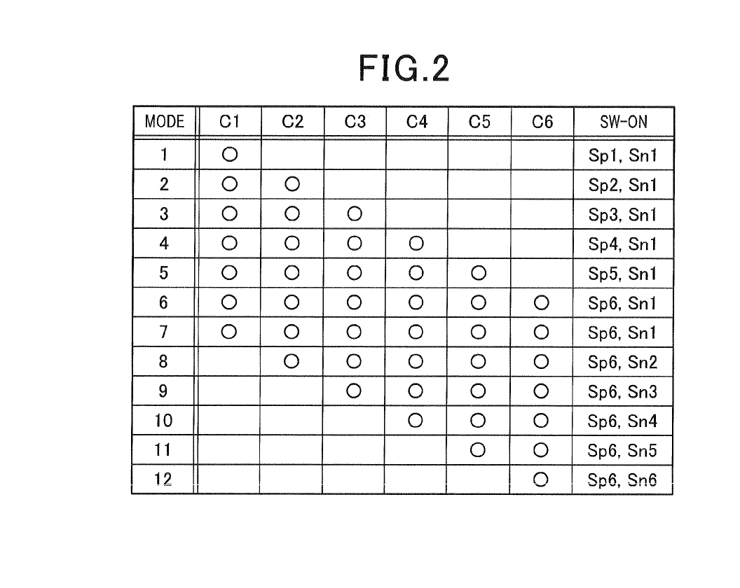

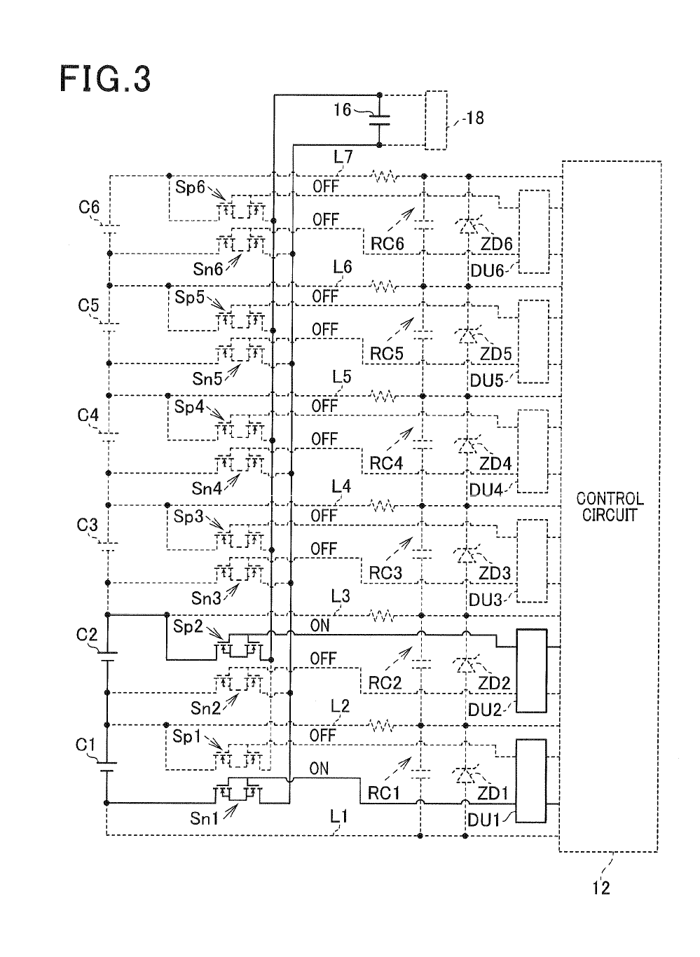

Specifically, the control circuit 12 performs an AC voltage generation process. In this process, a module is selected which is connected to the connector 18 by the opening and closing operation of the ith p side switching element Sp (i) and the ith n side switching element Sn (i) to convert DC voltage of the assembled battery 10 to AC voltage which is outputted to the connector 18. In the present embodiment, AC voltage is outputted from the connector 18 by sequentially selecting 12 modes shown in FIG. 2. For example, if mode 2 is selected, as shown in FIG. 3, only the second p side switching element Sp2 and the first n side switching element Sn1 are closed. Thereby, a positive electrode terminal of a second module C2 and a negative electrode terminal of a first module C1 are connected to the capacitor 16. That is, voltage across a series connection of the first module C1 and the second module C2 is applied to the capacitor 16. Note that, in the present embodiment, modes 1 to 12 shown in FIG. 2 correspond to one period of AC voltage.

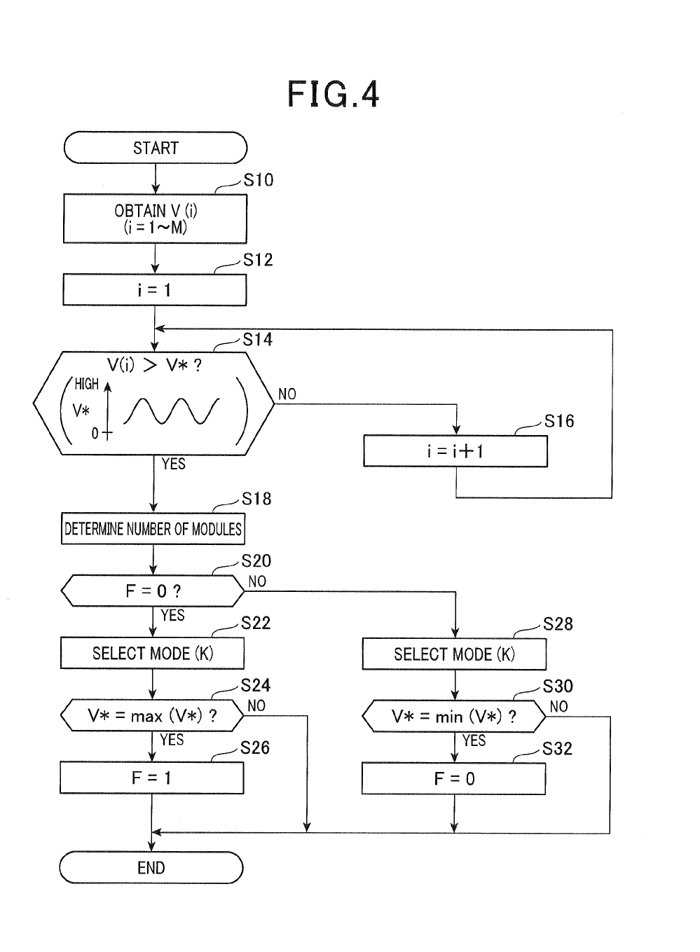

FIG. 4 shows a procedure of an AC voltage generation process according to the first embodiment. This process is repeatedly to performed, for example, at a predetermined period by the control circuit 12.

In this AC voltage generation process, first, in step S10, the control circuit 12 obtains each difference in potential (hereinafter, referred to as voltage between terminals V (i)) between a negative 15 electrode terminal of the assembled battery 10 (the negative electrode terminal of the first module C1) and the positive electrode terminal of the ith module C (i) (i=1 to M). Note that M indicates the number of modules included in the assembled battery 10, that is, 6.

Next, in step S12, the control circuit 12 initializes the parameter i. In step S14, the control circuit 12 determines whether or not the voltage between terminals V (i) exceeds a command value V*. This process is for determining the number of modules to be connected to the capacitor 16. In the present embodiment, the command value V* is a sine wave having a period of a system power supply (commercial power supply) (e.g. 50 Hz or 60 Hz) and is not less than 0. Note that, in the present embodiment, the maximum value of the command value V* is set to a value less than the voltage across the assembled battery 10 (voltage across a series connection of the first to sixth modules C1 to C6).

If a negative determination is made in step S14, in step S16, the control circuit 12 increments the value of the parameter i by one in step S16, and the process returns to the step S14. Meanwhile, if a positive determination is made in step S14, the process proceeds to step S18, in which the control circuit 12 determines that the number of modules to be connected to the capacitor 16 is the current value of the parameter i.

In successive step S20, the control circuit 12 determines whether or not the value of a voltage gradient flag F is 0. If the voltage gradient flag F is 0, a state is indicated where the number of modules to be connected to the capacitor 16 is increased. If the voltage gradient flag F is 1, a state is indicated where the number of modules to be connected to the capacitor 16 is decreased. Note that, in the present embodiment, an initial value of the voltage gradient flag F is set to 0.

If a positive determination is made in step S20, the process proceeds to step S22. In step S22, it is in a state where the number of modules to be connected to the capacitor 16 is increased, and the control circuit 12 selects a mode (K) (K=1 to 6) corresponding to the number of modules determined in the step S18. Specifically, of modes 1 to 6, a mode is selected which has the number of modules same as the determined number of modules.

In successive step S24, the control circuit 12 determines whether or not the command value V* has reached the maximum value thereof. This process is for determining whether or not it is changed from a state where the number of modules to be connected to the capacitor 16 is increased to a state where the number of modules to be connected to the capacitor 16 is decreased.

If a positive determination is made in step S24, the control circuit 12 determines that it is changed to a state where the number of modules to be connected to the capacitor 16 is decreased, and the process proceeds to step S26. In step S26, the control circuit 12 sets the value of the voltage gradient flag F to 1.

Meanwhile, if a negative determination is made in step S20, the process proceeds to step S28. In step S28, it is in a state where the number of modules to be connected to the capacitor 16 is decreased, and the control circuit 12 selects a mode (K) (K=7 to 12) corresponding to the number of modules determined in the step S18. Specifically, of modes 7 to 12, a mode is selected which has the number of modules same as the determined number of modules.

In successive step S30, the control circuit 12 determines whether or not the command value V* has reached the minimum value thereof. This process is for determining whether or not it is changed from a state where the number of modules to be connected to the capacitor 16 is decreased to a state where the number of modules to be connected to the capacitor 16 is increased.

If a positive determination is made in step S30, the control circuit 12 determines that it is changed to a state where the number of modules to be connected to the capacitor 16 is increased, and the process proceeds to step S32. In step S32, the control circuit 12 sets the value of the voltage gradient flag F to 0.

Note that if a negative determination is made in step S24 or S30, or the process in step S26 or S32 is completed, the AC voltage generation process is ended.

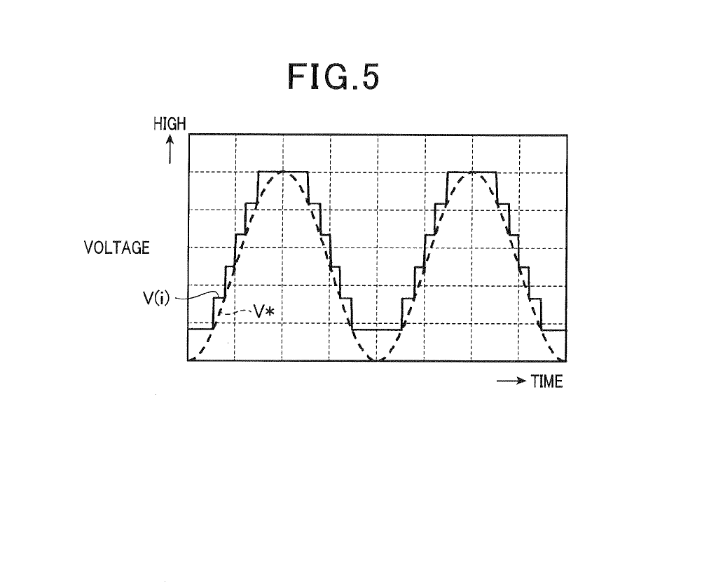

According to the AC voltage generation process described above, as shown in FIG. 5, the magnitude of the voltage between terminals V (i) and the magnitude of the command value V* are compared with each other. Hence, the selection mode is sequentially changed from 1 to 12. Thereby, the number of modules connected to the capacitor 16 gradually increases, and thereafter gradually decreases. Therefore, as shown in FIG. 6, stepped AC voltage can be outputted, which simulates AC voltage, from the connector 18.

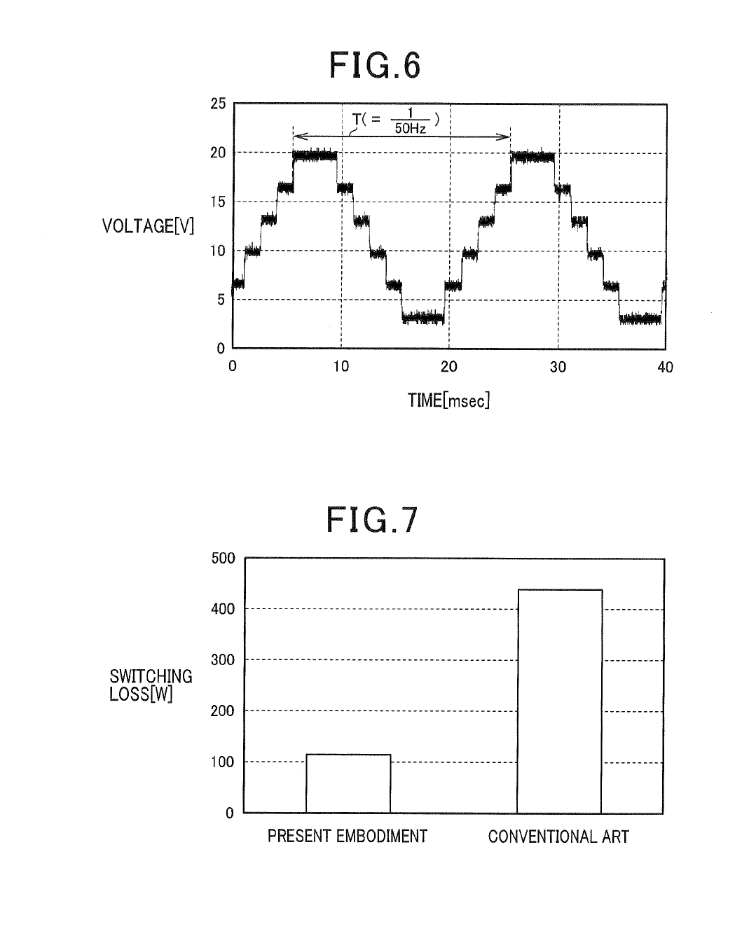

In addition, according to the AC voltage generation process described above, as shown in FIG. 7, compared with a case where AC voltage is generated by using a technique disclosed in JP-A-2006-320074 (hereinafter, referred to as conventional art), switching loss caused when DC voltage is converted to AC voltage can 30 be significantly decreased. This is because, in the present embodiment, switching frequencies of the ith p side switching element Sp (i) and the ith n side switching element Sn (i) where AC voltage is being generated can be significantly lower than the switching frequency in the conventional art.

According to the embodiment described above, the following advantages can be obtained.

(1) To convert DC voltage of the assembled battery 10 to AC voltage which is outputted from the connector 18, the AC voltage generation process is performed in which a module is selected which is connected to the connector 18 by the opening and closing operation of the ith p side switching element Sp (i) and the ith n side switching element Sn (i). According to this process, switching frequencies of the ith p side switching element Sp (i) and the ith n side switching o10 element Sn (i) can be significantly lowered when DC voltage is converted to AC voltage. Hence, power conversion efficiency can be a high level when AC voltage is generated. In addition, switching noise can be reduced.

(2) In the AC voltage generation process, during one period of AC voltage outputted from the connector 18, the opening and closing operation of the ith p side switching element Sp (i) and the ith n side switching element Sn (i) is performed so that all the numbers of times of connections between each of the modules C (i) and the capacitor 16 are the same. Hence, variation in capacity of all the modules C (i) can be appropriately suppressed.

(3) In the AC voltage generation process, a module initially connected to the capacitor 16 is fixed to the first module C1 every one period during which the number of modules connected to the capacitor 16 increases and decreases (a period of time from the start of mode 1 to the end of mode 12). Hence, the times for making each module release heat (the time corresponding to five modes) can be equalized, thereby preventing the temperature of part of the modules from being excessively high. Note that, to provide the above advantages, the mode initially selected during one period of AC voltage is not limited to mode 1, but may be any of modes 2 to 12.

### Second Embodiment

Hereinafter, the second embodiment will be described focusing on differences from the first embodiment.

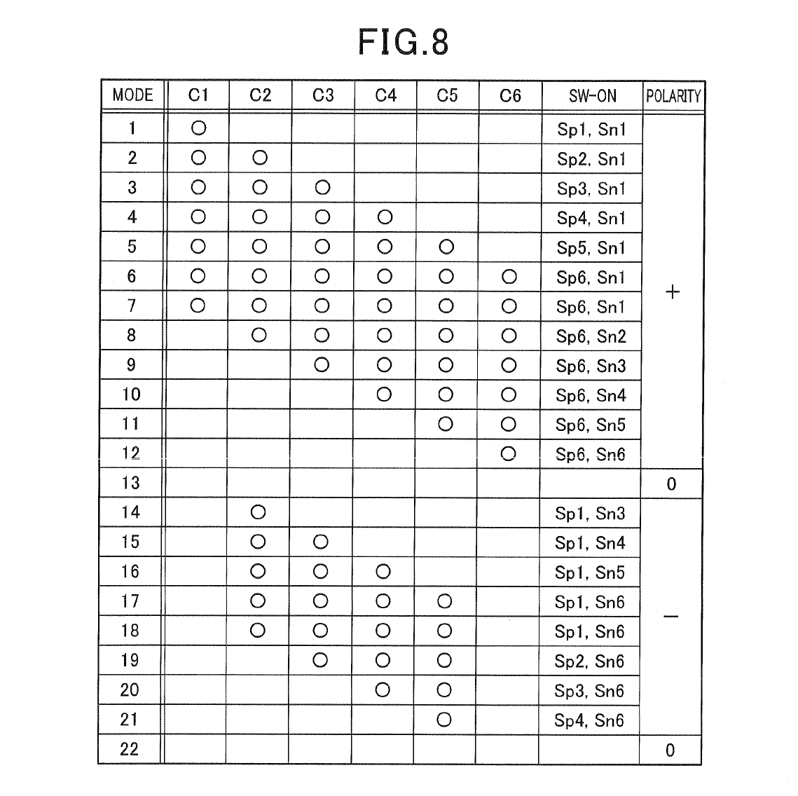

In the present embodiment, an AC power supply generation process is performed for outputting AC voltage similar to that of a system power supply from the connector 18. In particular, by using selection modes shown in FIG. 8, polarity of voltage applied to the capacitor 16 is alternately changed between positive and negative. Modes 1 to 12 are the same as those shown in FIG. 2. In the modes 1 to 12, the polarity of voltage applied to the capacitor 16 becomes positive. In addition, in mode 13 and mode 22, all the p side switching elements Sp (i) and the n side switching element Sn (i) are opened to set the number of selected modules to 0. In mode 14 to mode 21, the polarity of voltage applied to the capacitor 16 becomes negative.

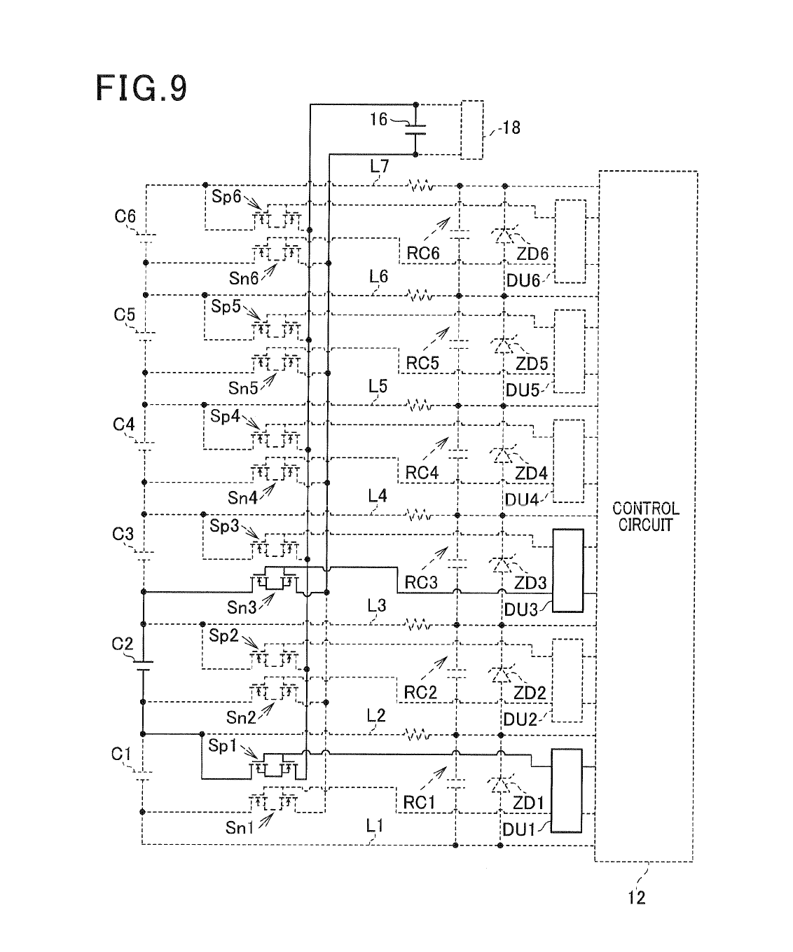

Specifically, if mode 14 is selected, as shown in FIG. 9, only the first p side switching element Sp1 and the third n side switching element Sn3 are closed, whereby a positive electrode terminal and a negative electrode terminal of the second module C2 are connected to the capacitor 16.

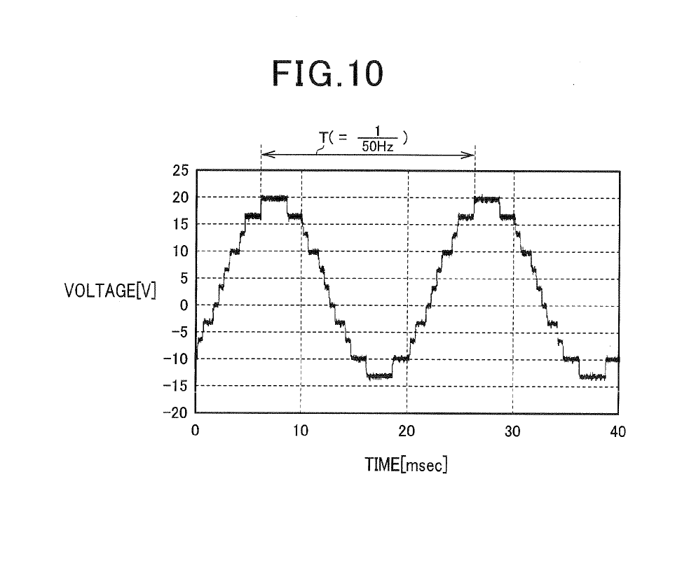

By sequentially changing the selection mode described above from 1 to 22, as shown in FIG. 10, AC voltage can be outputted from the connector 18. Note that, in the present embodiment, one period during which the number of modules connected to the capacitor 16 increases and decreases is a period of time from the start of mode 1 to the end of mode 12 or a period of time from the start of mode 14 to the end of mode 21.

According to the embodiment described above, advantages same as those described in (1) and (3) of the first embodiment can be obtained.

### Third Embodiment

Hereinafter, the third embodiment will be described focusing on differences from the second embodiment.

In the present embodiment, the circuit configuration of the power conversion apparatus is modified.

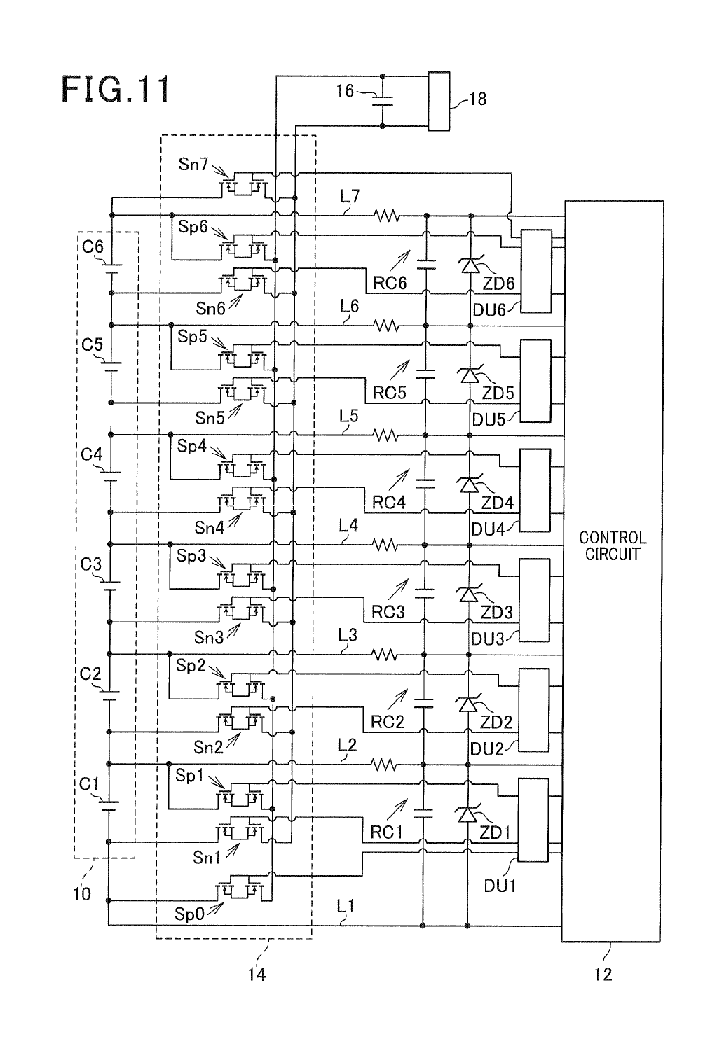

FIG. 11 shows the whole configuration of a system according to the present embodiment. Note that, in FIG. 11, the same parts as those of FIG. 1 are denoted with the same reference numerals for the sake of convenience.

As shown In FIG. 11, the converter 14 further includes a 0th p side switching element SpO and a seventh n side switching element Sn7. Specifically, a negative electrode terminal of the first module C1 is connected to one (first end) of the two ends of the capacitor 16, which is connected to the ith p side switching element Sp (i) (i=1 to 6), via the zeroth p side switching element Sp0. In addition, a positive electrode terminal of the sixth module C6 is connected to the other (second end) of the two ends of the capacitor 16, which is connected to the ith n side switching element Sn (i), via the seventh n side switching element Sn7. In the present embodiment, as the zeroth p side switching element SpO and the seventh n side switching element Sn7, a pair of N channel MOSFETs, whose sources are short-circuited to each other, are used as well as the ith p side switching element Sp (i) and the ith n side switching element Sn (i). Note that, in the present embodiment, the zeroth p side switching element Sp0 is opened and closed by the control circuit 12 via a first drive circuit DU1. The seventh n side switching element Sn7 is opened and closed by the control circuit 12 via a sixth drive circuit DU6.

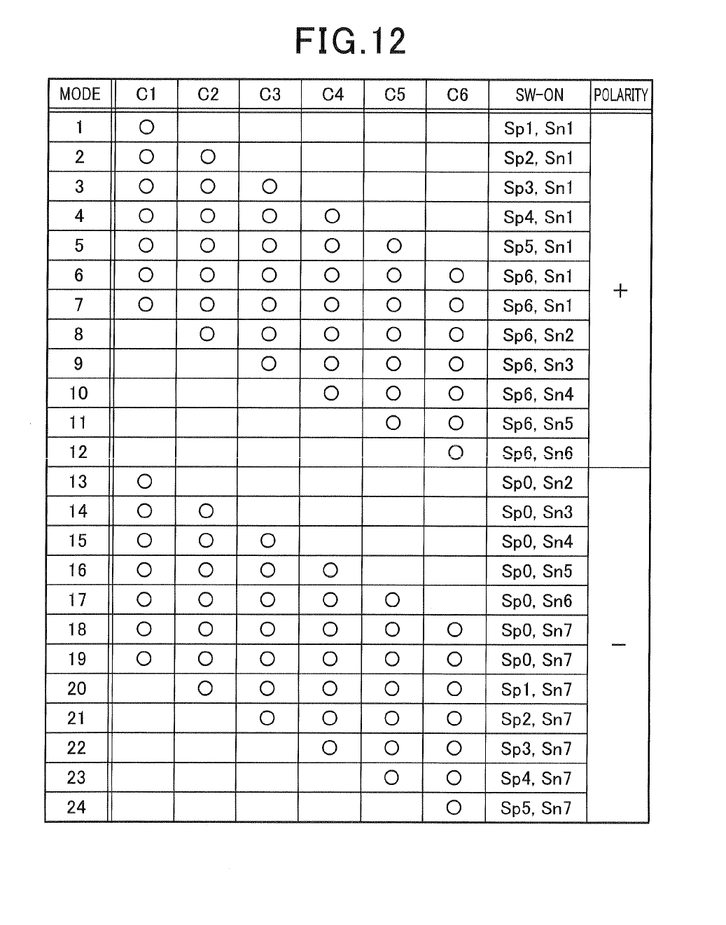

FIG. 12 shows selection modes of modules according to the present embodiment

By adding the zeroth p side switching element SpO and the seventh n side switching element Sn7, mode 13 to mode 24 can be realized in which the polarity of output voltage becomes negative. According to such selection modes, during one period of AC voltage whose polarity is inverted, all the numbers of times of connections between each of the modules C (i) and the connector 18 can be the same. Hence, variation in capacity of all the modules C (i) can be appropriately suppressed.

### Fourth Embodiment

Hereinafter, the fourth embodiment will be described focusing on differences from the first embodiment.

In the present embodiment, the circuit configuration of the power conversion apparatus is modified.

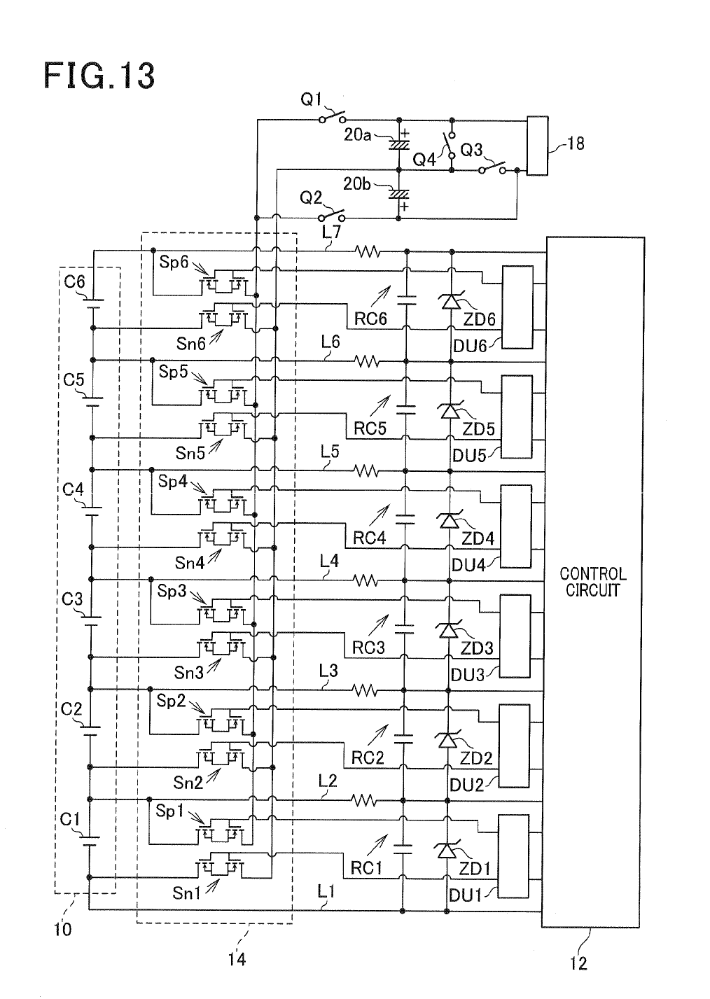

FIG. 13 shows the whole configuration of a system according to the present embodiment. Note that, in FIG. 13, the same parts as those of FIG. 1 are denoted with the same reference numerals for the sake of convenience.

As shown in FIG. 13, the present embodiment includes a pair of capacitors (hereinafter, referred to as first capacitor 20a and second capacitor 20b) having polarity. In particular, negative electrode terminals of the first capacitor 20a and the second capacitor 20b are short-circuited to each other. Note that, in the present embodiment, electrolytic capacitors are used as the first capacitor 20a and the second capacitor 20b.

A positive electrode terminal of the first capacitor 20a is connected to a positive electrode terminal of the ith module C (i) via a first switching element Q1 and the ith p side switching element Sp (i). In addition, a positive electrode terminal of the second capacitor 20b is connected to a positive electrode terminal of the ith module C (i) via a second switching element Q2 and the ith p side switching element Sp (i). Furthermore, each negative electrode terminal of the first capacitor 20a and the second capacitor 20b is connected to a negative electrode terminal of the ith module C (i) via the ith n side switching element Sn (i).

A positive electrode terminal of the first capacitor 20a is connected to one end (first end) of the connector 18. A negative electrode terminal of the first capacitor 20a is connected to the other end (second end) of the connector 18 via a third switching element Q3. In addition, a positive electrode terminal of the second capacitor 20b is connected to the other end (second end) of the connector 18. Furthermore, both ends of the first capacitor 20a are short-circuited via a fourth switching element Q4.

Note that, in the present embodiment, as the first to fourth switching elements Q1 to Q4, a pair of N-channel MOSFETs, whose sources are short-circuited to each other, are used. In addition, the switching elements Q1 to Q4, which are not shown, are opened and closed by the control circuit 12 via any of the drive circuits DU (i).

Next, an AC voltage generation process according to the present embodiment is described.

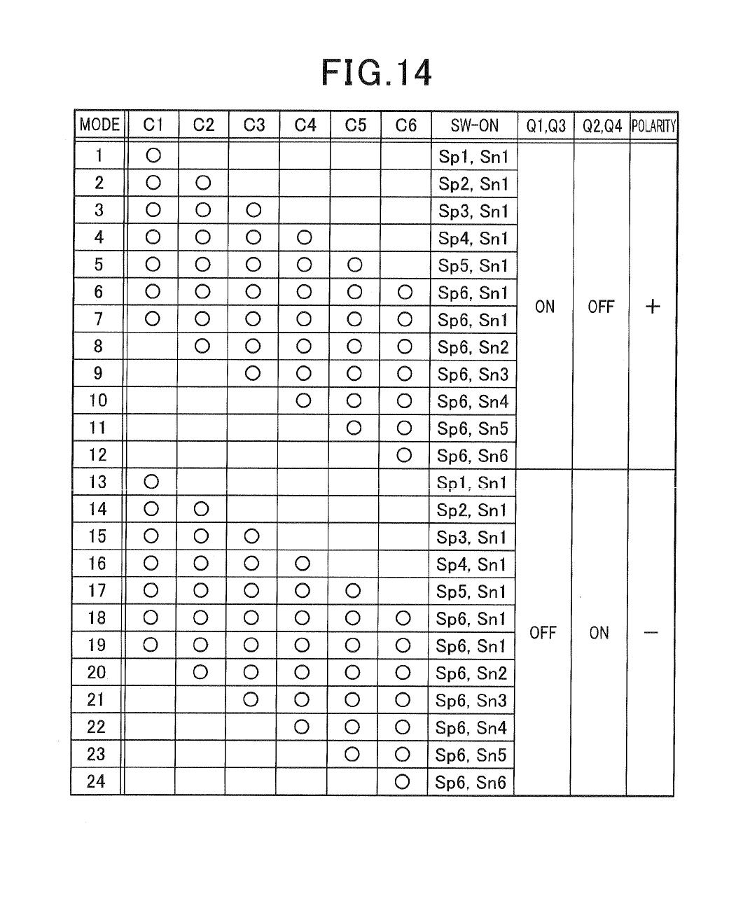

In the present embodiment, as described in the second and third embodiments, AC voltage, whose polarity is inverted, is outputted from the connector 18. This can be realized by selection modes shown in FIG. 14. In particular, selection modes of the present embodiment are the same as the modes shown in FIG. 2 concerning the ith p side switching element Sp (i) and the ith n side switching element Sn (i). Based on the configuration, during a period of time during which polarity of output voltage is positive, the first switching element Q1 and the third switching element Q3 are closed, and the second switching element Q2 and the fourth switching element Q4 are opened. Thereby, voltage having positive polarity is outputted from the connector 18 via the first capacitor 20a. Meanwhile, during a period of time during which polarity of output voltage is negative, the first switching element Q1 and the third switching element Q3 are opened, and the second switching element Q2 and the fourth switching element Q4 are closed. Thereby, voltage having negative polarity is outputted from the connector 18 via the second capacitor 20b.

According to the embodiment described above, advantages same as those described in (1) and (3) of the first embodiment can be obtained from the configuration in which AC voltage, whose polarity is inverted, can be outputted.

### Fifth Embodiment

Hereinafter, the fifth embodiment will be described focusing on differences from the first embodiment.

In the present embodiment, the circuit configuration of the power conversion apparatus is modified.

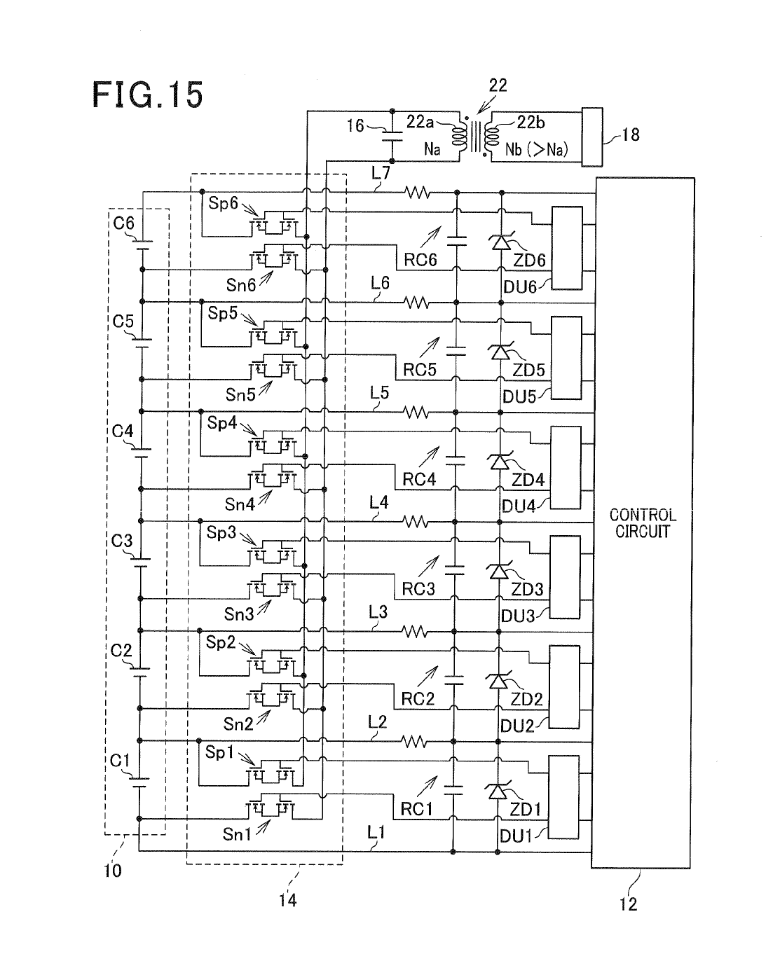

FIG. 15 shows the whole configuration of a system according to the present embodiment. Note that, in FIG. 15, the same parts as those of FIG. 1 are denoted with the same reference numerals for the sake of convenience.

As shown in FIG. 15, the capacitor 16 is connected to a primary coil 22a of a transformer 22. A secondary coil 22b of the transformer 22 is connected to the connector 18. In the present embodiment, the number of turns Nb of the secondary coil 22b is larger than the number of turns Na of the primary coil 22a. That is, the transformer 22 configures a step-up means (section) which increases input voltage.

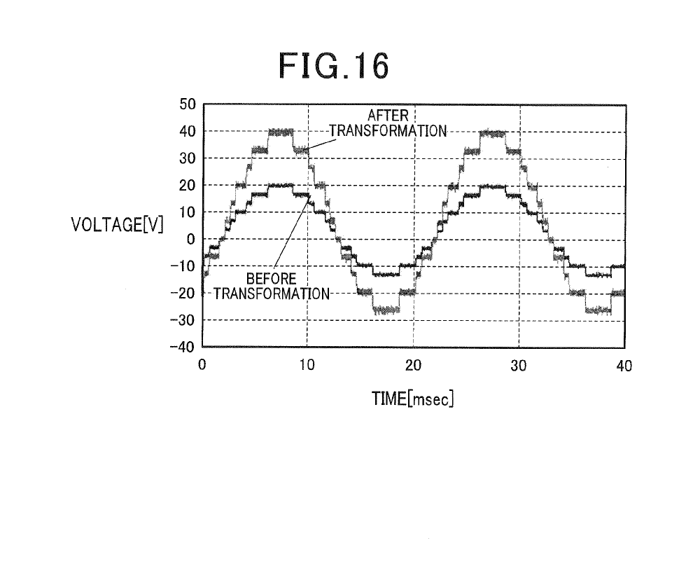

According to the embodiment described above, as shown in FIG. 16, AC voltage outputted from the connector 18 can be increased. That is, even when the terminal voltage of the assembled battery 10 is lower than the voltage required for external loads, AC voltage outputted from the connector 18 can be voltage meeting the voltage required for external loads.

Furthermore, according to the present embodiment, the assembled battery 10 can be insulated from external loads.

### Sixth Embodiment

Hereinafter, the sixth embodiment will be described focusing on differences from the fifth embodiment.

In the present embodiment, the technique for increasing voltage is modified.

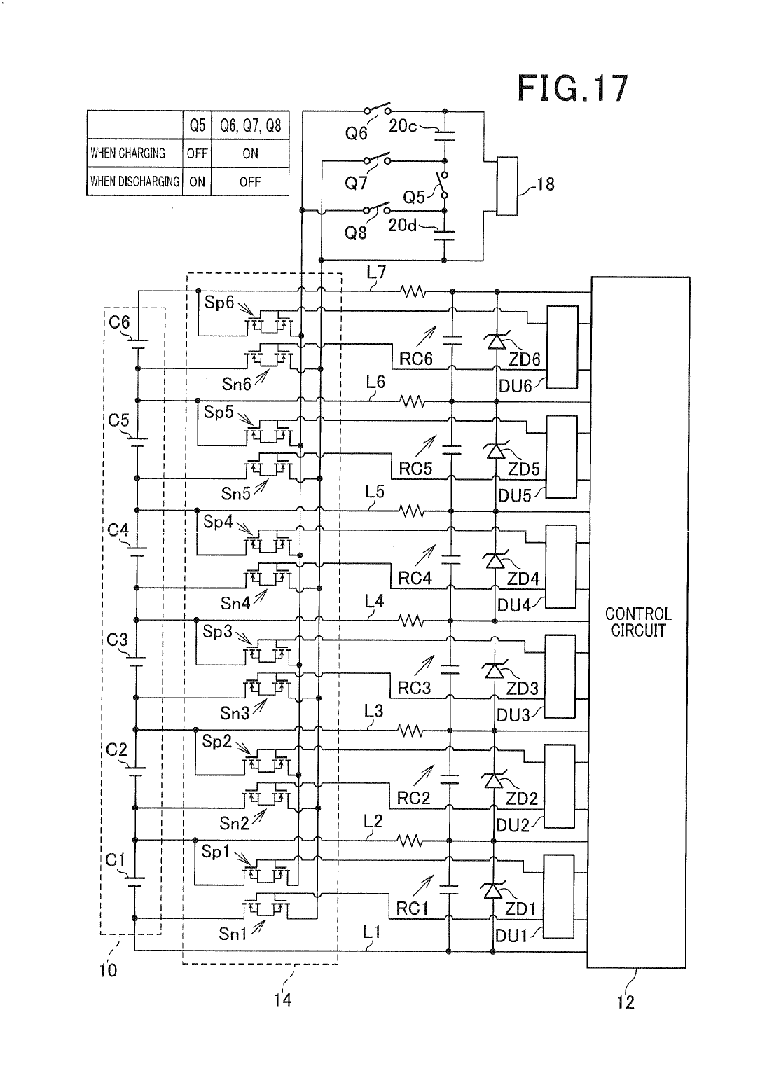

FIG. 17 shows the whole configuration of a system according to the present embodiment. Note that, in FIG. 17, the same parts as those of FIG. 15 are denoted with the same reference numerals for the sake of convenience.

As shown in FIG. 17, a third capacitor 20c is connected to a fourth capacitor 20d via a fifth switching element Q5. One (first end) of the two ends of the third capacitor 20c, which is at the opposite side of the fifth switching element Q5, is connected to one end of the connector 18. One (first end) of the two ends of the fourth capacitor 20d, which is at the opposite side of the fifth switching element Q5, is connected to the other end of the connector 18.

One (first end) of the two ends of the third capacitor 20c, which is at the connector 18 side, is connected to the positive electrode terminal of the ith module C (i) via a sixth switching element Q6 and the ith p side switching element Sp (i). In addition, the other (second end) of the two ends of the third capacitor 20c, which is at the fifth switching element Q5 side, is connected to the negative electrode terminal of the ith module C (i) via a seventh switching element Q7 and the ith n side switching element Sn (i).

The other (second end) of the two ends of the fourth capacitor 20d, which is at the fifth switching element Q5 side, is connected to the positive electrode terminal of the ith module C (i) via an eighth switching element Q8 and the ith p side switching element Sp (i). In to addition, one (first end) of the two ends of the fourth capacitor 20d, which is at the connector 18 side, is connected to the negative electrode terminal of the ith module C (i) via the ith n side switching element Sn (i).

Note that, in the present embodiment, a pair of N-channel MOSFETs, whose sources are short-circuited to each other, are used as the fifth to eighth switching elements Q5 to Q8. In addition, the switching elements Q5 to Q8 are opened and closed by the control circuit 12 via any of the ith drive circuit DU (i).

Next, an AC voltage generation process according to the present embodiment is described.

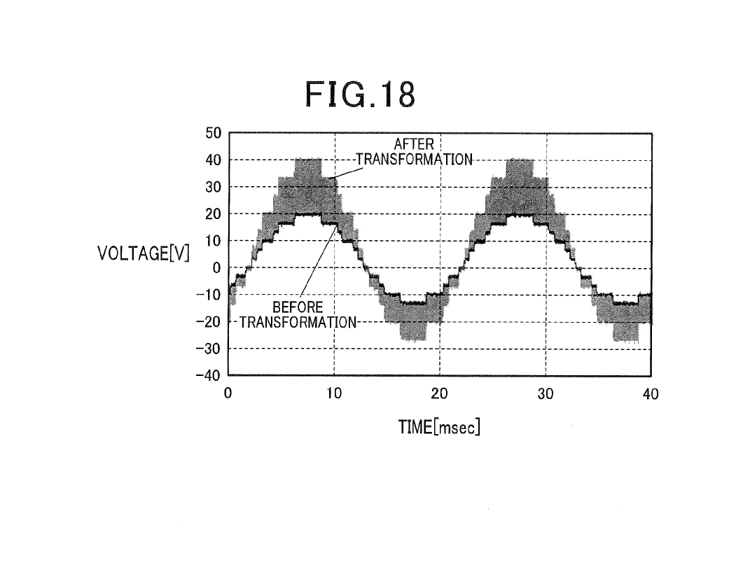

In the present embodiment, basically, while the ith p side switching element Sp (i) and the ith n side switching element Sn (i) are opened and closed by the selection modes shown in FIG. 2, the fifth to eighth switching elements Q5 to Q8 are opened and closed. Specifically, in each of the selection modes, first, the fifth switching element Q5 is opened, and the sixth to eighth switching elements Q6 to Q8 are closed. Thereby, the third capacitor 20c and the fourth capacitor 20d are charged. Thereafter, the fifth switching element Q5 is closed, and the sixth to eighth switching elements Q6 to Q8 are opened. Thereby, voltage across the third capacitor 20c and the fourth capacitor 20d are outputted from the connector 18. Hence, as shown in FIG. 18, increased AC voltage can be outputted from the connector 18.

According to the embodiment described above, AC voltage outputted from the connector 18 can be increased as well.

### Seventh Embodiment

Hereinafter, the seventh embodiment will be described focusing on differences from the first embodiment.

In the present embodiment, the AC voltage generation process is modified.

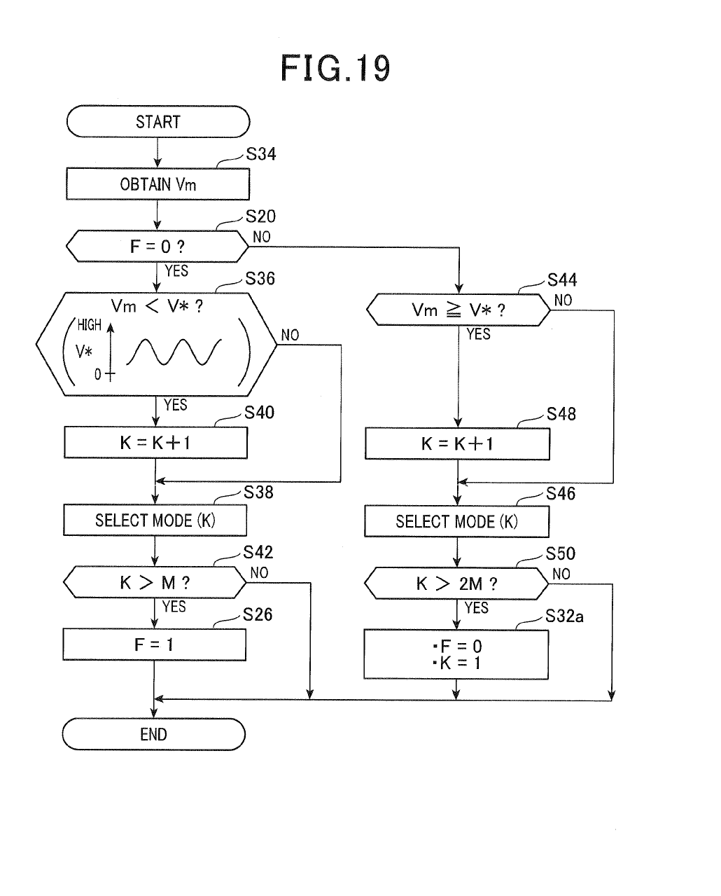

FIG. 19 shows a procedure of an AC voltage generation process according to the present embodiment. This process is repeatedly performed, for example, at a predetermined period by the control circuit 12. Note that, in FIG. 19, the same steps as those of FIG. 4 are denoted with the same step numbers for the sake of convenience.

In this AC voltage generation process, first, in step S34, the control circuit 12 obtains voltage across the module corresponding to the mode currently selected (hereinafter, referred to as module voltage Vm). Specifically, for example, if mode 2 is selected, the module voltage Vm is voltage across a series connection of the first module C1 and the second module C2.

If step S34 is completed, the process proceeds to step S20. If a positive determination is made in step S20, the process proceeds to step S36, in which the control circuit 12 determines whether or not the module voltage Vm is less than the command value V*. This process is for determining whether or not it is in a state where the selection mode should be changed. Note that the maximum value of the command value V* is set to a value slightly higher than the voltage across the assembled battery 10 (voltage across the series connection of the first to sixth modules C1 to C6). The minimum value of the command value V* is set to a value lower than the voltage across a single module.

If a negative determination is made in step S36, the control circuit 12 determines that it is not in a state where the selection mode should be changed. Then, the process proceeds to step S38, in which the control circuit 12 maintains the current selection mode (K) (K=1 to 12).

Alternatively, if a positive determination is made in step S36, the control circuit 12 determines that it is in a state where the selection mode should be changed. Then, the process proceeds to step S40, in which the control circuit 12 increments the value of the selection parameter K by one. Thereby, in the successive step S38, the selection mode is changed. Note that, in the present embodiment, an initial value of the selection parameter K is set to 1.

In successive step S42, the control circuit 12 determines whether or not the value of the selection parameter K has exceeded M. M is set to 6, which is the number of modules serving as selection objects in the AC voltage generation process. This process is for determining whether or not it is changed from a state where the number of modules to be connected to the capacitor 16 is increased to a state where the number of modules to be connected to the capacitor 16 is decreased.

If a positive determination is made in step S24, the control circuit 12 determines that it is changed to a state where the number of modules to be connected to the capacitor 16 is decreased, and the process proceeds to step S26.

After the voltage gradient flag F is set to 1 in step S26, a negative determination is made in step S20. Then, the process proceeds to step S44, in which the control circuit 12 determines whether or not the module voltage Vm is equal to or more than the command value V*. This process is for, as well as the process in the step S36, determining whether or not it is in a state where the selection mode should be changed.

If a negative determination is made in step S44, the control circuit 12 determines that it is not in a state where the selection mode should be changed. Then, the control circuit 12 maintains the current selection mode (K) in step S46.

Alternatively, if a positive determination is made in step S44, the control circuit 12 determines that it is in a state where the selection mode should be changed. Then, the process proceeds to step S48, in which the control circuit 12 increments the value of the selection parameter K by one. Thereby, in the successive step S46, the selection mode is changed.

In the successive step S50, the control circuit 12 determines whether or not the value of the selection parameter K has exceeded 2×M. This process is for determining whether or not it is changed from a state where the number of modules to be connected to the capacitor 16 is decreased to a state where the number of modules to be connected to the capacitor 16 is increased.

If a positive determination is made in step S50, the control circuit 12 determines that it is changed to a state where the number of modules to be connected to the capacitor 16 is increased, and the process proceeds to step S32a. In step S32a, the control circuit 12 sets the value of the voltage gradient flag F to 0 and sets the value of the selection parameter K to 1.

Note that if a negative determination is made in step S42 or S50, or the process in step S26 or S32a is completed, the AC voltage generation process is ended.

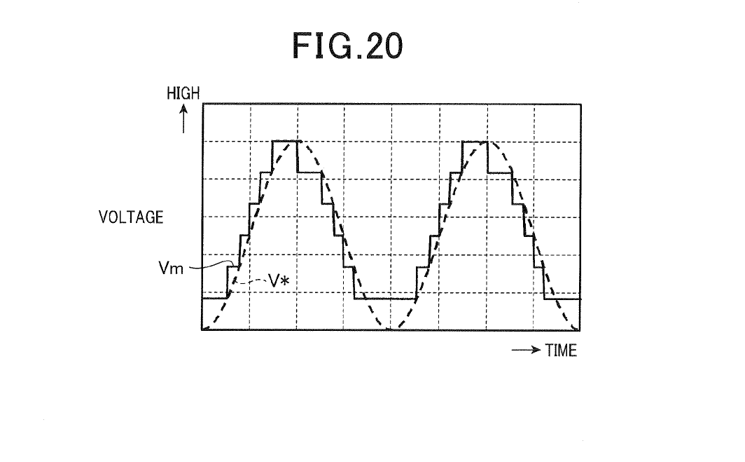

According to the AC voltage generation process described above, as shown in FIG. 20, the magnitude of the module voltage Vm and the magnitude of the command value V* are compared with each other. Then, the selection mode is sequentially changed from 1 to 12.

According to the embodiment described above, advantages same as those described in (1) and (3) of the first embodiment can be obtained.

### Other Embodiments

The above embodiments may be modified as below.

The selection object is not limited to that illustrated in the first embodiment. For example, in the configuration which does not include a means (section) for transforming an input voltage (e.g. transformer), only two or more and part of the whole modules 30 configuring the assembled battery 10 may be the selection objects to generate AC voltage so as to meet the voltage required for external loads. In this case, for example, the control circuit 12 may include a means (section) for calculating a voltage required for external loads or obtaining that from an external unit, and a means (section) for calculating the number of modules to be serving as the selection objects which can realize the calculated or obtained voltage.

In addition, the selection objects are not limited to a plurality of modules which are connected in series, but may include modules of the assembled battery 10 which are separated from each other. Even in this case, for example, in the first embodiment, if current paths which connect modules serving as the selection objects with the capacitor 16 and an opening and closing means (section) for opening and closing the current paths are appropriately arranged, it in can be considered that the AC voltage generation process can be performed.

In the above embodiments, the number of selection objects is increased or decreased by one to output AC voltage. However, the number of selection objects may be increased or decreased by two or more to output AC voltage. In addition, in the above embodiments, the minimum number of connected selection objects is 1 or 0. However, the minimum number of connected selection objects may be 2 or more depending on the voltage required for external loads.

The transformation means (section) is not limited to that Illustrated in the fifth embodiment. For example, the transformation means may be a step-down means (section) in which the number of turns Na of the primary coil 22a is increased so as to be larger than the number of turns Nb of the secondary coil 22b, to decrease input voltage. In addition, the transformation means is not limited to that illustrated in the sixth embodiment. For example, the number of series connections of capacitors may be three or more.

The assembled battery is not limited to that illustrated in the first embodiment, but may be, for example, a fuel battery.

The power conversion apparatus is not limited to being installed in a vehicle.

Hereinafter, aspects of the above-described embodiments will be summarized.

As an aspect of the embodiment, a power conversion apparatus is provided, which is applied to an assembled battery (10) which is a series connection of a plurality of unit batteries (C (i): i=1 to 6), two or more and at least part of the plurality of unit batteries being selection objects. The apparatus includes a voltage output section (18, 22, 20c, 20d, Q5 to Q8) which outputs voltage; opening and closing sections (Sp (i), Sn (i), Sp0, Sn7) each of which is provided on each current path connecting each of the selection objects with the voltage output section and which is opened and closed to open and close the current path; and an operation section (12) which operates the opening and closing sections so that the voltage output o10 section outputs AC voltage.

According to the embodiment, by opening and closing the opening and closing sections, the number of unit batteries connected to the voltage output section gradually increases or decreases, and voltage applied from the assembled battery to the voltage output 15 section gradually increases or decreases. Hence, compared with, for example, the technique described in JP-A-2006-320074, voltage outputted from the voltage output section to an external unit can be AC voltage while decreasing switching loss caused when DC voltage is converted to AC voltage.

It will be appreciated that the present invention is not limited to the configurations described above, but any and all modifications, variations or equivalents, which may occur to those who are skilled in the art, should be considered to fall within the scope of the present invention.

What is claimed is:

1. A power conversion apparatus, which is applied to an assembled battery which is a series connection of a plurality of unit batteries, two or more and at least part of the plurality of unit batteries being selection objects, the apparatus comprising:
a voltage output section which outputs voltage;
opening and closing sections each of which is provided on each current path connecting each of the selection objects with the voltage output section and which is opened and closed to open and close the current path; and
an operation section which operates the opening and closing sections so that the voltage output section outputs AC voltage.

2. The power conversion apparatus according to claim 1, wherein the voltage output section is an output terminal.

3. The power conversion apparatus according to claim 1, wherein
the voltage output section comprises:
a transformation section which is connected to the selection objects via the opening and closing sections and which transforms input voltage; and
an output terminal which outputs the voltage transformed by the transformation section.

4. The power conversion apparatus according to claim 3, wherein
the transformation section is a transformer.

5. The power conversion apparatus according to claim 3, wherein
the transformation section comprises:
a plurality of capacitors which are connected to each other in series;
a first switch section provided between the capacitors, the first switch section being opened when charging the capacitors from the selection objects via the opening and closing sections and being closed when discharging the capacitors to the output terminal; and
a second switch section which is closed so as to connect the opening and closing sections with the capacitors when charging the capacitors and which is opened so as to disconnect the opening and closing sections and the capacitors when discharging the capacitors.

6. The power conversion apparatus according to claim 1, wherein
the opening and closing sections are provided on current paths each of which connects a positive electrode terminal and a negative electrode terminal of each of the selection objects with the voltage output section.

7. The power conversion apparatus according to claim 1, wherein the selection objects are at least part of the unit batteries connected to each other in series.

8. The power conversion apparatus according to claim 7, wherein, during one period of AC voltage outputted from the voltage output section, the operation section opens and closes the opening and closing sections so that the numbers of times of connections between the respective selection objects and the voltage output section are the same.

9. The power conversion apparatus according to claim 7, wherein, the operation section opens and closes the opening and closing sections on condition that the selection object initially connected to the voltage output section is fixed every one period during which the number of selection objects connected to the voltage output section increases and decreases.

10. The power conversion apparatus according to claim 1, further comprising a detection section which detects voltage across each of the selection objects connected to the voltage output section, wherein
the operation section opens and closes the opening and closing sections on the basis of a result of a comparison between the magnitude of a command value of AC voltage and the magnitude of a detection value of the detection section.
